(19) United States
(12) Patent Application Publication
(10) Pub. No.: US 2016/0301301 A1
(43) Pub. Date: Oct. 13, 2016

(54) VOLTAGE SUPPLY CIRCUITS AND CONTROLLING METHODS THEREFOR

(71) Applicant: MediaTek Inc., Hsin-Chu (TW)

(72) Inventors: Chien-Wei KUAN, Hsinchu City (TW); Yen-Hsun HSU, Hengshan Township, Hsinchu County (TW); Tun-Shih CHEN, Linluo Township, Pingtung County (TW)

(21) Appl. No.: 15/038,561

(22) PCT Filed: Jan. 14, 2015
(86) PCT No.: PCT/CN2015/070676

§ 371 Date: May 23, 2016

Related U.S. Application Data
(60) Provisional application No. 61/927,146, filed on Jan. 14, 2014.

(51) Int. Cl. H02M 3/04; H02M 1/08

(52) U.S. Cl. CPC H02M 3/04; H02M 1/08; H02M 2001/0009

(57) ABSTRACT

A voltage supply circuit is provided. The voltage supply circuit may operate at a first or second mode to generate an output voltage at an output node. The voltage supply circuit includes a compensation circuit, a comparator circuit, an inductor, and a driver circuit. The compensation circuit generates a compensation signal according to a feedback signal related to the output voltage. The comparator circuit compares the compensation signal with a first reference signal to generate a comparison signal. The inductor is coupled to the output node. The driver circuit receives the comparison signal and generates a driving voltage to the inductor according to the comparison signal. When the voltage supply circuit enters the second mode from the first mode, a duty of the comparison signal is increased to broaden an operation bandwidth of the voltage supply circuit in a predetermined period at the second mode.

### CROSS REFERENCE TO RELATED APPLICATIONS

This application claims the benefit of U.S. Provisional Application No. 61/927,146, filed on Jan. 14, 2014, the contents of which are incorporated herein by reference.

### TECHNICAL FIELD

The invention relates to a voltage supply circuit, and more particularly to a voltage supply circuit with transient enhancement for an output voltage.

### BACKGROUND

Generally, a voltage supply may operate at a pulse width modulation (PWM) mode or a pulse frequency modulation (PFM) mode according to a loading state of the voltage supply. When a large loading is at an output node of the voltage supply, the voltage supply operates at the PWM mode for better performance. When the loading decreases, the voltage supply will switch to operate at the PFM mode for power saving. However, when the loading becomes large again, the voltage supply then switches back to operate at the PWM mode from the PFM mode. At this time, due to the large loading, a large amount of current is drawn from the output node. If the voltage supply fails to generate sufficient current during the mode switching, an output voltage at the output node immediately drops to an excessive level. Therefore, the voltage supply does not work normally, such as crashing.

### SUMMARY

Thus, it is desirable to provide a voltage supply circuit which is capable of enhancing an output voltage in a short time when the voltage supply circuit switches between at least two modes.

An exemplary embodiment of a voltage supply circuit is provided. The voltage supply circuit may operate at a first mode to generate an output voltage at an output node. The voltage supply circuit comprises a compensation circuit, a comparator circuit, an inductor, and a driver circuit. The compensation circuit generates a compensation signal according to a feedback signal related to the output voltage. The comparator circuit receives the compensation signal and a first reference signal and compares the compensation signal with the first reference signal to generate a comparison signal. The inductor is coupled to the output node. The driver circuit receives the comparison signal and generates a driving voltage to the inductor according to the comparison signal. When the voltage supply circuit enters a second mode from the first mode, a duty of the comparison signal is increased to broaden an operation bandwidth of the voltage supply circuit in a predetermined period at the second mode.

Another exemplary embodiment of a controlling method for a voltage supply circuit is provided. The voltage supply circuit generates an output voltage at an output node of the voltage supply circuit by using an operation bandwidth. The controlling method comprises steps of operating at a first mode; at a first time point, entering a second mode from the first mode; and broadening the operation bandwidth in a predetermined period starting from the first time point at the second mode.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary embodiment of a voltage supply circuit;

FIG. 2 shows an exemplary embodiment of a timing chart showing mode switching of the voltage supply circuit in FIG. 1;

FIG. 3 shows one exemplary embodiment of a compensation circuit of the voltage supply circuit in FIG. 1;

FIG. 4 shows another exemplary embodiment of a compensation circuit of the voltage supply circuit in FIG. 1; and

FIG. 5 shows an exemplary embodiment of a controlling method.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

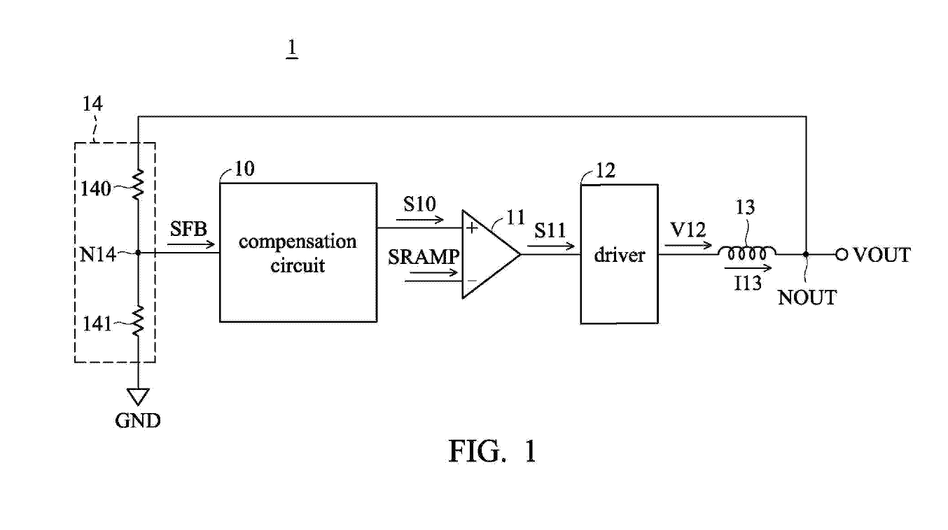

In an exemplary embodiment shown in FIG. 1, a voltage supply circuit 1 may operate at a first mode or a second mode and may generate an output voltage VOUT at an output node NOUT at each of the first and second modes. In the embodiment, the first mode is a pulse width modulation (PWM) mode for better performance for generating the output voltage VOUT, while the second mode is a pulse frequency modulation (PFM) mode for power saving. Referring to FIG. 1, the voltage supply circuit 1 comprises a compensation circuit 10, a comparator 11, a driver circuit 12, an inductor 13, and a voltage divider 14. At each of the first and second modes, the compensation circuit 10 receives a feedback signal SFB and generates a compensation signal S10 according to the feedback signal SFB. In the embodiment, the feedback signal SFB is related to the output voltage VOUT. As shown in FIG. 1, the voltage divider 14 receives the output voltage VOUT and performs a voltage division operation to the output voltage VOUT to generate the feedback signal SFB. In an embodiment, the voltage divider 14 comprises two resistors 140 and 141, and the feedback signal SFB is generated at the joint node N14 between the resistors 140 and 141. Thus, the feedback signal SFB is related to the output voltage VOUT. In another embodiment, the voltage divider 14 is omitted, and the output voltage VOUT directly serves as the feedback signal SFB.

A positive input terminal (+) of the comparator 11 receives the compensation signal S10, and a negative input terminal (−) thereof receives a reference signal. In the embodiment, a ramp signal SRAMP serves as the reference signal input to the negative input terminal of the comparator 11. The comparator 11 compares the compensation signal S10 with the ramp signal SRAMP to generate a comparison signal S11 according to the comparison result. In the embodiment, the ramp signal SRAMP has a saw-tooth waveform. The comparison signal S11 is then transmitted to the driver 12. When the driver circuit 12 receives the comparison signal S11, the driver circuit 12 generates a driving voltage V12 according to the received comparison signal, and the driving voltage V12 is applied to the inductor 13. Through applying the driving voltage V12 to the inductor 13, the output voltage VOUT is generated at the output node NOUT.

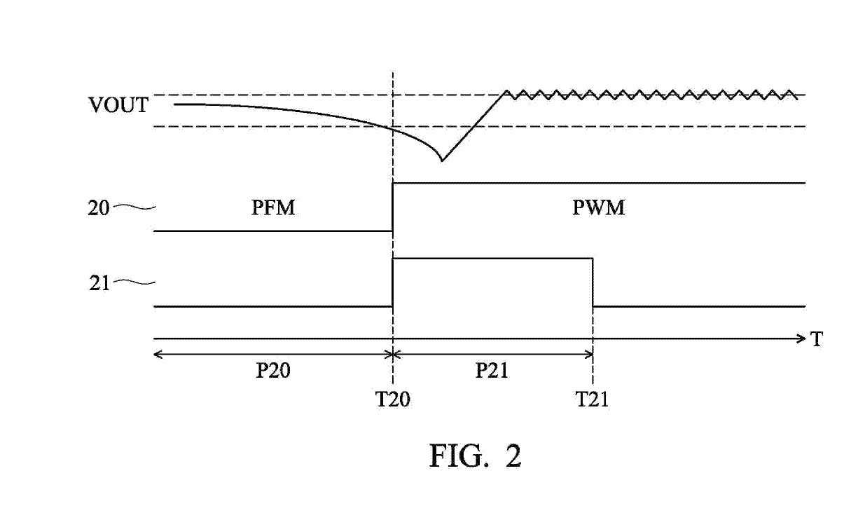

In the following, the operation of the voltage supply circuit 1 during the mode switching will be described by referring to FIGS. 1 and 2. In FIG. 2, a label 20 represents timing of the mode switching, and a label 21 represents timing of occurrence of a predetermined period for broadening the operation bandwidth of the voltage supply circuit. It is assumed that the voltage supply circuit 1 is operating at the PFM mode due to a less loading in a period P20. The degree of the loading of the voltage supply circuit 1 can be determined according to the amount of the current drawn from the output node NOUT. When it is detected that the loading becomes greater according to the large current drawn from the output node NOUT, the voltage supply circuit 1 switches to the PWM mode from the PFM mode for batter performance at a time point T20. At the PWM mode, in a predetermined period P21 from the time point T20 to a time point T21, the operation bandwidth of the voltage supply circuit 1 is broadened, that is, the operation bandwidth is broader than a predetermined width for normal operation of the voltage supply circuit 1. After the time point T21, the operation bandwidth of the voltage supply circuit 1 becomes to be the predetermined width. Then, the voltage supply circuit 1 operates by using the operation bandwidth with the predetermined bandwidth at the PFM mode.

After the voltage supply circuit 1 switches to the PWM mode, the voltage supply circuit 1 first operates by using the broadened operation bandwidth in the predetermined period P21 and then operates by using the operation bandwidth with the predetermined bandwidth in the predetermined period P21. Through broadening the operation bandwidth of the voltage supply circuit 1 in the predetermined period P21, a large current which flows through the inductor 13 is generated. Thus, there is a sufficient current for the loading, and the output voltage VOUT may not immediately drop too level. Through the building of the predetermined period T21, a gain boosting window is opened. In the gain boosting window, the voltage supply circuit 1 operates at the broadened operation bandwidth to increase the current flowing through the inductor 13. In the embodiment, the gain boosting window is small, and the gain boosting window is close when the output voltage VOUT rises to a sufficient level, Thus, the stability of the voltage supply circuit 1 may not be affected disadvantageously.

In the embodiment, the operation bandwidth of the voltage supply circuit 1 is broadened by increasing the duty of the comparison signal S11 in FIG. 1. The driving circuit 12 generates the driving voltage V12 according to the comparison signal S11, and the amount of the driving voltage V12 is determined according to the duty of the comparison signal S11. The driving voltage V12 is provided to the inductor 13. Thus, the current I13 flowing through the inductor 13 is determined by the comparison signal S11, particularly by the duty of the comparison signal S11. Based on the operation o the driving circuit 12 and the behavior of the inductor 13, the driving circuit 12 generates a greater driving voltage V12 for generating a large current I13 flowing through the inductor 13 according to the comparison signal S11 with a greater duty; while the driving circuit 12 generates a less driving voltage V12 for generating a small current I13 flowing through the inductor 13 according to the comparison signal S11 with a less duty. Thus, when the duty of the comparison signal S11 is increased in the predetermined period P21, the driving voltage V12 is also increased, which broadens the operation bandwidth of the voltage supply circuit 1 in equivalence for generating a large current I13.

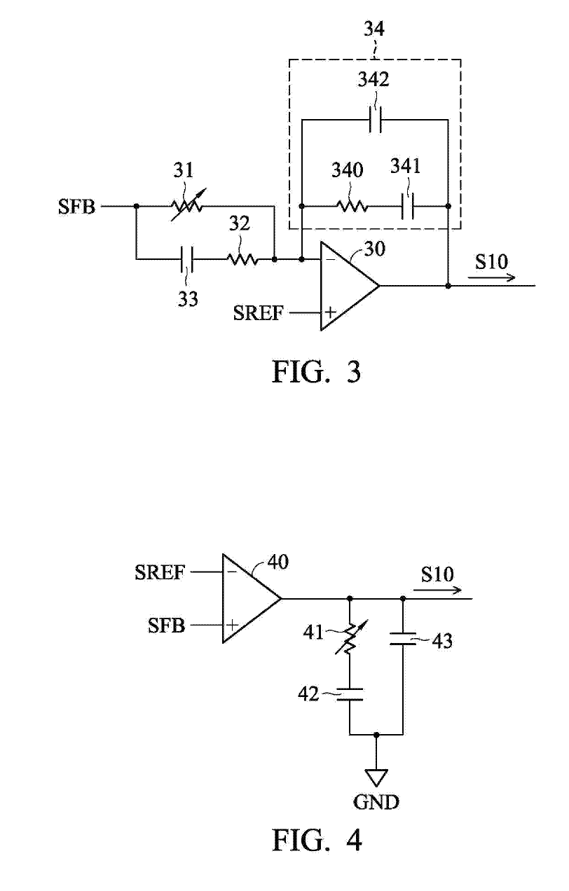

There are several manners for increasing the duty of the comparison signal S11. One manner for increasing the duty of the comparison signal S11 is to broaden the gain bandwidth of the compensation circuit 10. In the following, how to increase the duty of the comparison signal S11 by broadening the gain bandwidth of the compensation circuit 10 will be described by referring to FIGS. 1, 3, and 4. FIG. 3 shows one exemplary embodiment of a compensation circuit 10 of the voltage supply circuit in FIG. 1. As shown in FIG. 3, the compensation circuit 10 comprises an operation amplifier 30, resistors 31 and 32, a capacitor 33, and a feedback circuit 34. In the embodiment, the resistor 31 is a variable resistor 31, while the resistor 32 has a fixed resistance value. The compensation circuit 10 receives the feedback signal SFB via an input node N30 in FIG. 1. The resistor 31 is coupled between the input node N30 and a negative input terminal (−) of the operational amplifier 30. The resistor 32 and the capacitor 33 are coupled in series between the input node N30 and the negative input terminal (−) of the operational amplifier 30. A positive input terminal (+) of the operational amplifier 30 receives a reference signal SREF30. The feedback circuit 34 is coupled between the negative input terminal (−) and an output terminal of the operational amplifier 30. Based on the operation of the compensation circuit 10 comprising the above elements shown in FIG. 3, the compensation signal S10 is generated at the output terminal of the operational amplifier 30. In the embodiment, the resistor 31 initially has a first resistance value. After the voltage supply circuit 1 switching to the PWM mode in the predetermined period P21, the resistor 31 switches to a second resistance value which is less than the first resistance value. In other words, in an operation period excluding the predetermined period P21, the resistor 31 has the first resistance value, while-in the predetermined period P21, the resistor 31 has the second resistance value. Through decreasing the resistance value of the resistor 31, the voltage level of the compensation signal S10 is increased rapidly, which broadens the gain bandwidth of the compensation circuit 10 in equivalence. At this time, since the voltage level of the compensation S10 is increased rapidly, the comparison signal S11 has an increased duty, thereby broadening the operation bandwidth of the voltage supply circuit 1.

In an embodiment, the feedback circuit 34 comprises a resistor 340 and capacitor 341 and 342. The resistor 340 and the capacitor 341 are coupled in series between the negative input terminal (−) and an output terminal of the operational amplifier 30. The capacitor 342 is coupled between the negative input terminal (−) and an output terminal of the operational amplifier 30. The structure of the feedback circuit 34 shown in FIG. 3 is an example and may be modified according to system requirements.

FIG. 4 shows another exemplary embodiment of a compensation circuit of the voltage supply circuit 10 in FIG. 1. As shown in FIG. 4, the compensation circuit 10 comprises a transconductance amplifier 40, a resistor 41, and capacitors 42 and 43. In the embodiment, the resistor 41. A positive terminal of the transconductance amplifier 40 receives the feedback signal SFB, and a negative terminal thereof receives a reference signal SREF40. The resistor 41 and the capacitor 42 are coupled in series between an output terminal of the transconductance amplifier 40 and a reference ground GND. The capacitor 43 is coupled between the output terminal of the transconductance amplifier 40. Based on the operation of the compensation circuit 1 comprising the above elements shown in FIG. 4, the compensation signal S10 is generated at the output terminal of the transconductance amplifier 40. In the embodiment, the resistor 41 initially has a first resistance value. However, after the voltage supply circuit 1 switches to the PWM mode—in the predetermined period P21, the resistor 41 switches to a second resistance value which is less than the first resistance value. In other words, in an operation period excluding the predetermined period P21, the resistor 41 has the first resistance value, while, in the predetermined period P21, the resistor 41 has the second resistance value. Through decreasing the resistance value of the resistor 41, the voltage level of the comparison signal S11 is increased rapidly, which broadens the gain bandwidth of the compensation circuit 10 in equivalence. At this time, since the voltage level of the comparison signal S11 is increased rapidly, the comparison signal S11 has an increased duty, thereby broadening the operation bandwidth of the voltage supply circuit 1.

One manner for increasing the duty of the comparison signal S11 is to increase the slope of the ramp signal SRAMP. In the following, how to increase the duty of the comparison signal S11 by increasing the slope of the ramp signal SRAMP will be described by referring to FIG. 1. According to the operation of the comparator 11, the voltage level S10 and the slope of the ramp signal SRAMP can affect the duty of the comparison signal S11. In the embodiment, the slope of the ramp signal SRAMP initially has a first slope value. After the voltage supply circuit 1 switches to the PWM mode—, in the predetermined period P21, the slope of the ramp signal SRAMP is decreased to have a second slope value which is less than the first slope value. In other words, in an operation period excluding the predetermined period P21, the ramp signal SRAMP has the first slope value, while-in the predetermined period P21, the ramp signal SRAMP has the second slope value. Through decreasing the slope of the ramp signal SRAMP, the comparison signal S11 which is generated by comparing the comparison signal S11 and the ramp signal SRAMP has an increased duty, thereby broadening the operation bandwidth of the voltage supply circuit 1.

In the embodiment, the ramp signal SRAMP is generated according to a feedback amount from the current I13 flowing through the inductor 13. The decrement of the slope of the ramp signal SRAMP can be achieved by decreasing the feedback amount from the current I13.

In the embodiment, the time point T21 is determined for preventing the phase margin of the compensation circuit 10 from becoming worst continuously. In an embodiment, there are ten switching cycles of the comparison signal S11 between the time point T20 and the time point T21. In detailed, an internal counter of the voltage supply circuit 1 starts counting the switching cycles of the comparison signal S11 at the time point T20 and then ends the counting as the count of the switching cycles thereof reaches ten. The time point when the counter ends the counting serves as the time point T21. The ten switching cycles of the comparison signal S11 occurring between the time point T20 and the time point T21 (that is in the predetermined period P21) are taken as an example. In other embodiment, the number of switching cycles of the comparison signal S11 between the time point T20 and the time point T21 is determined according to system requirements. Of course, the determination term of the predetermined period P21 is not limited to switching cycles, It can also be time units or other system conditions,

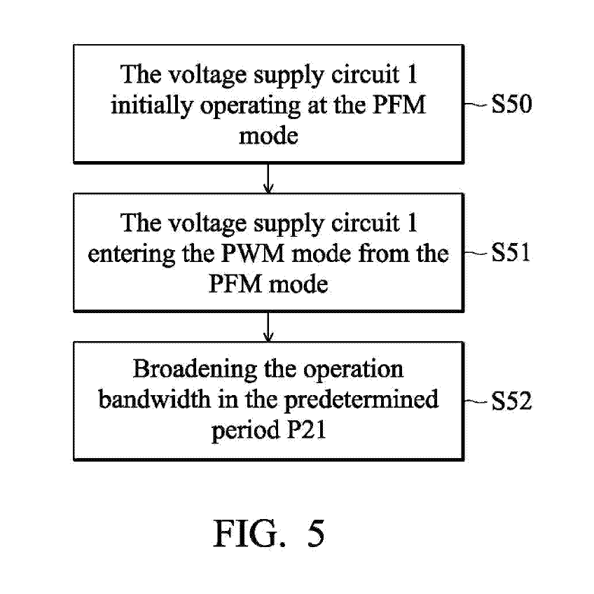

FIG. 5 shows an exemplary embodiment of a controlling method. The controlling method will be described by referring to FIGS. 1, 2, and 5. In the embodiment, the voltage supply circuit 1 is initially operate at the PFM mode (step S50). When it is detected that the loading of the voltage supply circuit 1 becomes greater according to the large current drawn from the output node NOUT, the voltage supply circuit 1 enters the PWM mode from the PFM mode at a time point T20 (step S51). After the voltage supply circuit 1 enters the PWM mode, the operation bandwidth is broadened in the predetermined period P21 starting from the time point T20 to the time point T21 (step S52).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A voltage supply circuit operating at a first mode and generating an output voltage at an output node comprising:
a compensation circuit generating a compensation signal according to a feedback signal related to the output voltage;
a comparator circuit receiving the compensation signal and a first reference signal and comparing the compensation signal with the first reference signal to generate a comparison signal;
an inductor coupled to the output node; and
a driver circuit receiving the comparison signal and generating a driving voltage to the inductor according to the comparison signal,
wherein when the voltage supply circuit enters a second mode from the first mode, a duty of the comparison signal is increased to broaden an operation bandwidth of the voltage supply circuit in a predetermined period at the second mode.

2. The voltage supply circuit as claimed in claim 1, wherein the compensation circuit comprises an amplifying circuit having a gain bandwidth, and, in the predetermined period, the duty of the comparison signal is increased by broadening the gain bandwidth of the amplifying circuit.

3. The voltage supply circuit as claimed in claim 2, wherein the compensation circuit has an input node receiving the feedback signal and comprises:
an operational amplifier having a first input terminal receiving a second reference signal, a second input terminal, and an output terminal generating the comparison signal;
a first resistor, coupled between the input node of the compensation circuit and the first input terminal of the operational amplifier, having a first resistance value in an operation period excluding the predetermined period;
a first capacitor and a second resistor coupled in series between the input node of the compensation circuit and the first input terminal of the operational amplifier;
a feedback circuit coupled between the first input terminal and the output terminal of the operation amplifier,
wherein in the predetermined period, the first resistor switches to have a second resistance value less than the first resistance value to broaden the gain bandwidth of the compensation circuit.

4. The voltage supply circuit as claimed in claim 2, wherein the compensation circuit comprises:
a transconductance amplifier having a first input terminal receiving the feedback signal, a second input terminal receiving a second reference signal, and an output terminal generating the comparison signal;
a first capacitor coupled between the output terminal of the transconductance amplifier and a reference ground; and
a resistor and a second capacitor coupled in series between the output terminal of the transconductance amplifier and the reference ground, wherein the resistor has a first resistance value in an operation period excluding the predetermined period,
wherein in the predetermined period, the resistor switches to have a second resistance value less than the first resistance value to broaden the gain bandwidth of the compensation circuit.

5. The voltage supply circuit as claimed in claim 1, wherein the first reference signal is a ramp signal, and, in the predetermined period, the duty of the comparison signal is increased by decreasing a slope of the ramp signal.

6. The voltage supply circuit as claimed in claim 1, wherein the first reference signal is related to a current flowing through the inductor.

7. A controlling method for a voltage supply circuit which generates an output voltage at an output node of the voltage supply circuit by using an operation bandwidth, the controlling method comprising:
operating at a first mode;
at a first time point, entering a second mode from the first mode; and
broadening the operation bandwidth in a predetermined period starting from the first time point at the second mode.

8. The controlling method as claimed in claim 7, wherein at each of the first mode and the second mode, the controlling method comprises:
generating a compensation signal according to a feedback signal related to the output voltage by using a gain bandwidth;
comparing the compensation signal with a reference signal to generate a comparison signal; and
generating a driving voltage to an inductor, which is coupled to the output node, according to the comparison signal,
wherein the step of broadening the operation bandwidth comprises:
in the predetermined, increasing a duty of the comparison signal to broaden the operation bandwidth.

9. The controlling method as claimed in claim 8, wherein in the step of increasing the duty of the comparison signal, the gain bandwidth is broadened to increase the duty of the comparison signal.

10. The controlling method as claimed in claim 8, wherein in the step of increasing the duty of the comparison signal, a slope of the reference signal is decreased to increase the duty of the comparison signal.

11. The controlling method as claimed in claim 10, wherein the first reference signal is related to a current flowing through the inductor.
